(19) United States
(12) Patent Application Publication
(10) Pub. No.: US 2023/0237374 A1
(43) Pub. Date: Jul. 27, 2023

(54) METHOD OF CONTROLLING MACHINE LEARNING MODEL AND SYSTEM PERFORMING THE SAME

(71) Applicant: SAMSUNG ELECTRONICS CO., LTD., Suwon-si (KR)

(72) Inventors: Wijik LEE, Suwon-si (KR); Heeseok EUN, Suwon-si (KR)

(73) Assignee: SAMSUNG ELECTRONICS CO., LTD., Suwon-si (KR)

(21) Appl. No.: 17/950,562

(22) Filed: Sep. 22, 2022

(30) Foreign Application Priority Data
Jan. 26, 2022 (KR) 10-2022-0011670

(51) Int. Cl. G06N 20/00; H04L 9/08

(52) U.S. Cl. CPC G06N 20/00; H04L 9/0825

(57) ABSTRACT

A method is provided. The method includes: generating a public key and a secret key, based on a master key and a parameter vector indicating parameters of a first layer of a machine learning model; generating encrypted data by encrypting, based on the public key, an input vector indicating input data of the machine learning model; generating decrypted data corresponding to an approximation value of an inner product of the parameter vector and the input vector by decrypting the encrypted data based on the secret key; and controlling the machine learning model based on the decrypted data to obtain an output value.

### CROSS-REFERENCE TO RELATED APPLICATION

This application claims priority to Korean Patent Application No. 10-2022-0011670, filed on Jan. 26, 2022, in the Korean Intellectual Property Office (KIPO), the disclosure of which is incorporated by reference herein in its entirety.

### BACKGROUND

### 1. Technical Field

Example embodiments relate generally to semiconductor integrated circuits, and more particularly to a method of controlling a machine learning model and a system performing the method.

### 2. Discussion of Related Art

Encryption schemes include symmetric encryption schemes and asymmetric encryption schemes. The symmetric encryption scheme may have high speed because a key used in decryption is the same as a key used in encryption, but have low security due to key exposure, and the like. The asymmetric encryption scheme has been proposed to solve the problems of the symmetric encryption schemes. The asymmetric encryption scheme utilizes a public key provided to a third party and a secret key possessed solely by a user. The user may receive a cyphertext that is encrypted using the public key and may decrypt the cyphertext using the secret key.

A public key encryption scheme based on learning with error (LWE) was proposed by Regev in 2005. The public key encryption scheme based on LWE and modifications thereof may be referred to as “LWE-based public key encryption”. The LWE-based public key encryption is still unsuitable for internet of things (IoT), transport layer security (TLS), cloud computing, server operation, etc., because of large size of parameter, low speed, vulnerability to attack using a quantum computer, and so on.

### SUMMARY

Some example embodiments may provide a method of controlling a machine learning model and a system performing the method, capable of reinforcing security of data used in machine learning.

According to example embodiments, a method includes: generating a public key and a secret key, based on a master key and a parameter vector indicating parameters of a first layer of a machine learning model; generating encrypted data by encrypting, based on the public key, an input vector indicating input data of the machine learning model; generating decrypted data corresponding to an approximation value of an inner product of the parameter vector and the input vector by decrypting the encrypted data based on the secret key; and controlling the machine learning model based on the decrypted data to obtain an output value.

According to example embodiments, a system includes: a storage device includes a storage controller and a nonvolatile memory device. The storage controller includes a processor configured to control a machine learning model; and a host device configured to control the storage device. The system is configured to: generate a public key and a secret key, based on a master key and a parameter vector indicating parameters of a first layer of the machine learning model; generate encrypted data by encrypting, based on the public key, an input vector indicating input data of the machine learning model; generate decrypted data corresponding to an approximation value of an inner product of the parameter vector and the input vector by decrypting the encrypted data based on the secret key; and control the machine learning model based on the decrypted data to obtain an output value.

According to example embodiments, a system includes: one or more memories; and one or more processors configured to control: a key generation device to generate a public key and a secret key, based on a master key and a parameter vector indicating parameters of a first layer of a machine learning model; an encryption device to generate encrypted data by encrypting, based on the public key, an input vector indicating input data of the machine learning model; a decryption device to generate decrypted data corresponding to an approximation value of an inner product of the parameter vector and the input vector by decrypting the encrypted data based on the secret key; and a machine learning engine to receive the decrypted data from the decryption device and control the machine learning model based on the decrypted data to obtain an output value.

The method of controlling a machine learning model and the system according to example embodiments may reinforce security of data used in machine learning and block attacks using quantum computers by incurring random noise in the encrypted data based on the functional encryption using the LWE problem and the lattice problem.

### BRIEF DESCRIPTION OF THE DRAWINGS

Example embodiments will be more clearly understood from the following detailed description taken in conjunction with the accompanying drawings.

FIG. 1 is a diagram illustrating a system according to example embodiments.

FIG. 2 is a flowchart illustrating a method of controlling a machine learning model according to example embodiments.

FIG. 3 is a block diagram illustrating a computing device according to example embodiments.

FIGS. 4A and 4B are diagrams for describing examples of a neural network structure that is driven by a machine learning device according to example embodiments.

FIG. 4C is a diagram illustrating an example of a node included in a neural network.

FIG. 5A is a diagram illustrating machine learning based on input data.

FIG. 5B is a diagram illustrating machine learning based on decrypted data generated by a method of controlling a machine learning model according to example embodiments.

FIG. 6 is a block diagram illustrating a key generation device included in a system according to example embodiments.

FIG. 7 is a block diagram illustrating an encryption device and a decryption device included in a system according to example embodiments.

FIG. 8 is a diagram for describing a node operation by a hidden node in a first hidden layer according to example embodiments.

FIG. 9A is a flow chart illustrating key generation in a method of controlling a machine learning model according to example embodiments.

FIG. 9B is a flow chart illustrating encryption in a method of controlling a machine learning model according to example embodiments.

FIG. 9C is a flow chart illustrating decryption in a method of controlling a machine learning model according to example embodiments.

FIG. 10 is a block diagram illustrating a learning with error (LWE) device included in a system according to example embodiments.

FIG. 11 is a block diagram illustrating a system according to example embodiments.

FIG. 12 is a block diagram illustrating a storage system including a storage device according to example embodiments.

FIGS. 13A, 13B, 13C and 13D are block diagrams illustrating a storage system according to example embodiments.

FIG. 14 is a flowchart illustrating a method of controlling a machine learning model according to example embodiments.

FIG. 15 is a diagram illustrating a configuration corresponding to the method of FIG. 14.

FIG. 16 is a flowchart illustrating a method of controlling a machine learning model according to example embodiments.

FIG. 17 is a diagram illustrating a configuration corresponding to the method of FIG. 16.

FIG. 18 is a block diagram illustrating a storage controller included in a storage device according to example embodiments.

FIG. 19 is a block diagram illustrating a nonvolatile memory device included in a storage device according to example embodiments.

FIG. 20 is a circuit diagram illustrating an equivalent circuit of a memory block included in a nonvolatile memory device according to example embodiments.

FIG. 21 is a block diagram illustrating an electronic device according to example embodiments.

### DETAILED DESCRIPTION

Various example embodiments will be described more fully hereinafter with reference to the accompanying drawings, in which some example embodiments are shown. In the drawings, like numerals refer to like elements throughout. The repeated descriptions may be omitted.

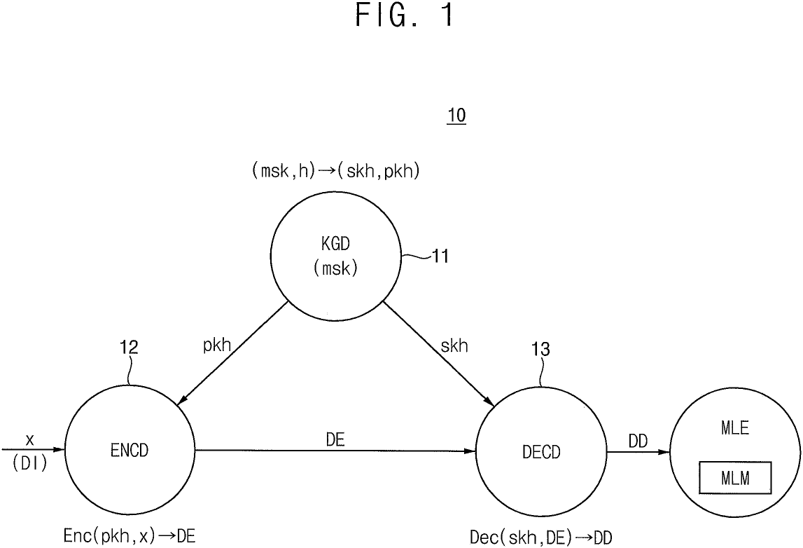

FIG. 1 is a diagram illustrating a system according to example embodiments.

Referring to FIG. 1, a system 10 includes a key generation device KGD 11, an encryption device ENCD 12, a decryption device DECD 13 and a machine learning engine MLE. The system may implement functional encryption using the key generation device 11, the encryption device 12, and the decryption device 13, and the machine learning engine MLE may control a machine learning model MLM using results of the functional encryption.

The functional encryption may obtain a value to which a function is applied, whereas the homomorphic encryption may allow mathematical operations to be performed on encrypted data or cyphertexts. In general, the functional encryption includes a setup algorithm, a secret key generation algorithm, an encryption algorithm and a decryption algorithm. The setup algorithm generates a master key and a public key using a security parameter as an input. The secret key generation algorithm generates a secret key using the master key and a given function as inputs. The encryption algorithm generates a cyphertext by encrypting a plaintext with the public key. In this regard, anyone possessing the public key may generate the cyphertext. The decryption algorithm may generate a function value with the secret key such that the function value corresponds to the plaintext to which the function is applied.

The key generation device 11 may perform the setup algorithm and the secret key generation algorithm of the functional encryption. The key generation device 11 may generate a public key pkh and a secret key skh based on a master key msk and a parameter vector h. The master key msk may be externally provided or generated in the key generation device 11. The system 10 may maintain security to prevent the master key msk from being externally exposed.

The encryption device 12 may perform the encryption algorithm of the functional encryption. The encryption device 12 may generate encrypted data DE by encrypting, based on the public key pkh, an input vector x indicating input data DI.

The decryption device 13 may perform the decryption algorithm of the functional encryption. The decryption device 13 may generate decrypted data DD corresponding to an approximation value of an inner product of the parameter vector h and the input vector x by decrypting the encrypted data DE based on the secret key skh.

The key generation device 11, the encryption device 12, and the decryption device 13 may be implemented as hardware, software or a combination of hardware and software, where software is program codes that are executed by a processor. According to example embodiments, the key generation device 11, the encryption device 12, and the decryption device 13 may be included in the same system, or may be distributed in respective systems that are connected through various interfaces.

The machine learning engine MLE may receive the decrypted data DD, rather than the input data DI, from the decryption device 13 and control the machine learning model MLM based on the decrypted data DD. An output value may be obtained based on an output of the machine learning model MLM, and the output value may correspond to the input data DI.

A related functional encryption using discrete logarithm (DL) problem may obtain a decrypted data corresponding to a value (e.g., g^{<h,}^{x>}) of an inter product <h, x> to which a specific function is applied, where <h, x> indicates the inner product of the parameter vector h and the input vector x. However, the functional encryption using DL problem may not provide the inner product itself and thus functional encryption using the DL problem may be applicable to restricted scenarios. In contrast, the related functional encryption using learning with error (LWE) problem may provide the inner product itself but the functional encryption using LWE problem is vulnerable to attacks using quantum computers.

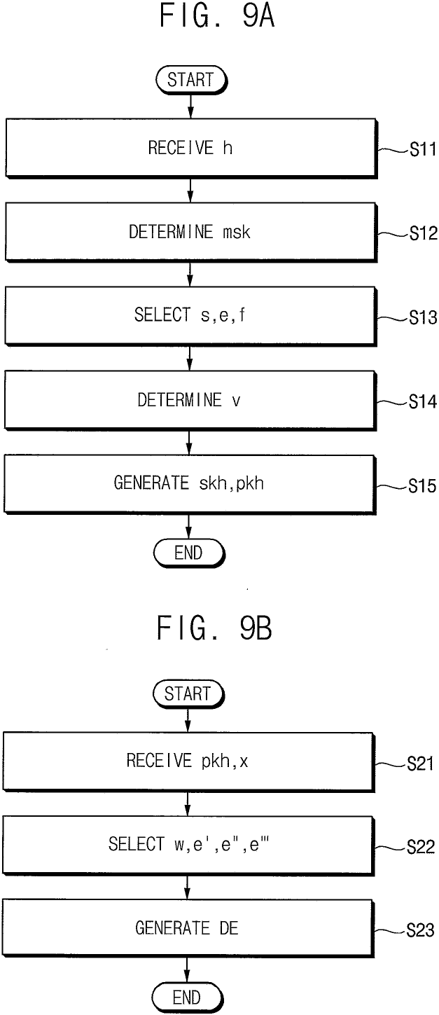

According to example embodiments, as will be described with reference to FIGS. 9A, 9B and 9C, the decrypted data DD may be generated based on the functional encryption using LWE problem and lattice problem such that the decrypted data DD is not the inner product <h, x> itself, but an approximation value of the inner product <h, x>. In this regard, random noise may be included in the decrypted data DD based on the functional encryption using the LWE problem and the lattice problem such that the decrypted data DD may be different from the inner product <h, x>. Using such decrypted data DD, security of the data used in machine learning may be reinforced and block the attacks using the quantum computer.

In some example embodiments, the parameter vector h may indicate parameters of a first hidden layer of the machine learning model MLM, and the decrypted data DD may indicate an approximation value of the inner product <h, x> of the parameter vector h and the input vector x. The inner product <h, x> may correspond to node operations of the first hidden layer.

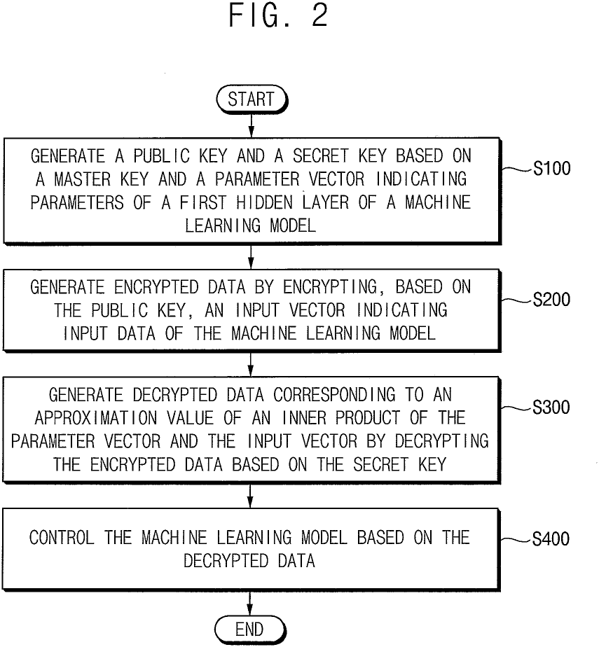

FIG. 2 is a flowchart illustrating a method of controlling a machine learning model according to example embodiments.

Referring to FIGS. 1 and 2, the key generation device 11 may generate the public key pkh and the secret key skh based on the master key msk and the parameter vector h indicating the first hidden layer of the machine learning model MLM (S100). An example of generating the public key pkh and the secret key skh will be described below with reference to FIG. 9A.

The encryption device 12 may generate the encrypted data DE by encrypting, based on the public key pkh, the input vector x indicating input data DI (S200). An example of generating the encrypted data DE will be described below with reference to FIG. 9B.

The decryption device 13 may generate decrypted data DD corresponding to an approximation value of the inner product <h, x> of the parameter vector h and the input vector x by decrypting the encrypted data DE based on the secret key skh (S300). An example of generating the decrypted data DD will be described below with reference to FIG. 9C.

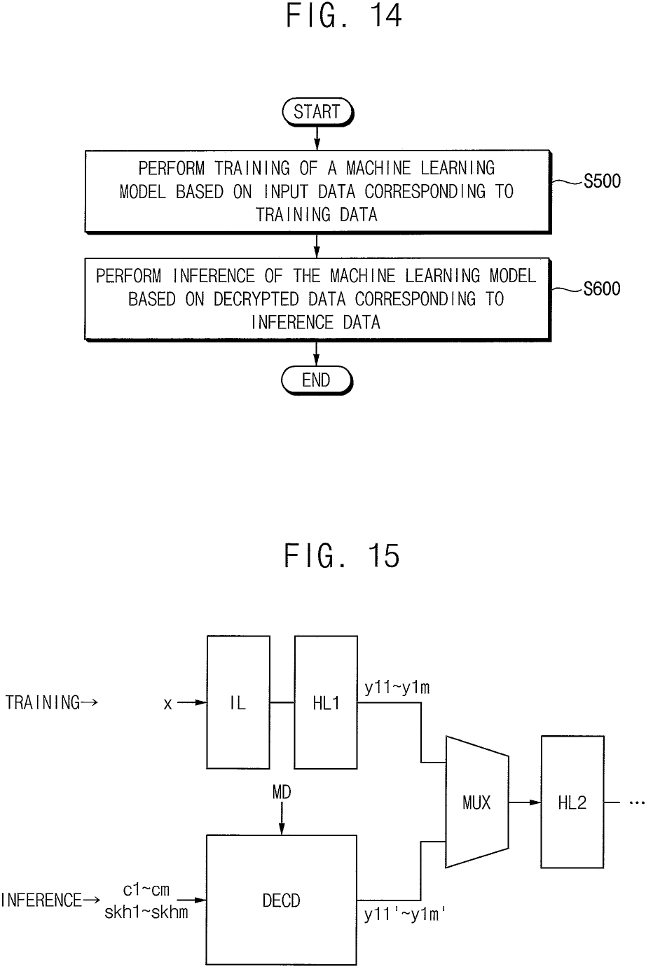

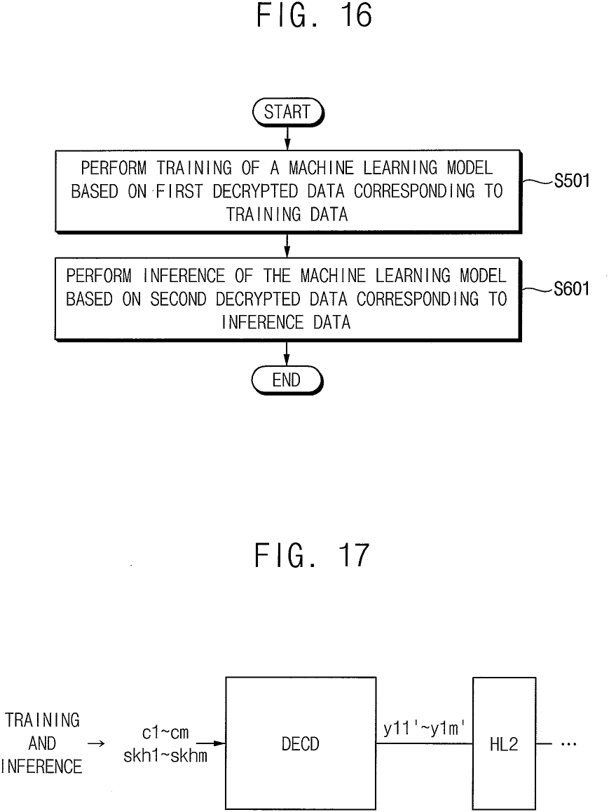

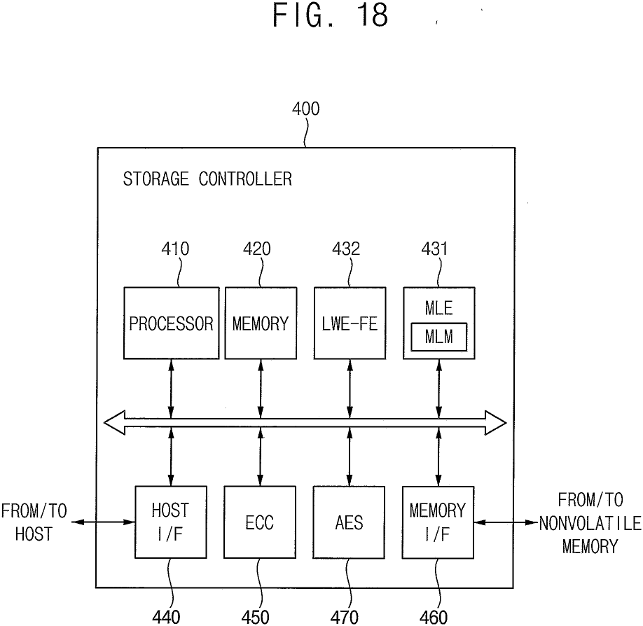

The machine learning engine MLE may control the machine learning model MLM based on the decrypted data DD (S400). In some example embodiments, as will be described below with reference to FIGS. 14 and 15, controlling the machine learning model MLM may include controlling an inference operation of the machine learning model MLM. In some example embodiments, as will be described below with reference to FIGS. 16 and 17, controlling the machine learning model MLM may include controlling a training operation of the machine learning model MLM in addition to the inference operation.

As such, the method of controlling a machine learning model and the system according to example embodiments may reinforce security of data used in machine learning and block attacks using quantum computers by incurring random noise in the encrypted data based on the functional encryption using the LWE problem and the lattice problem.

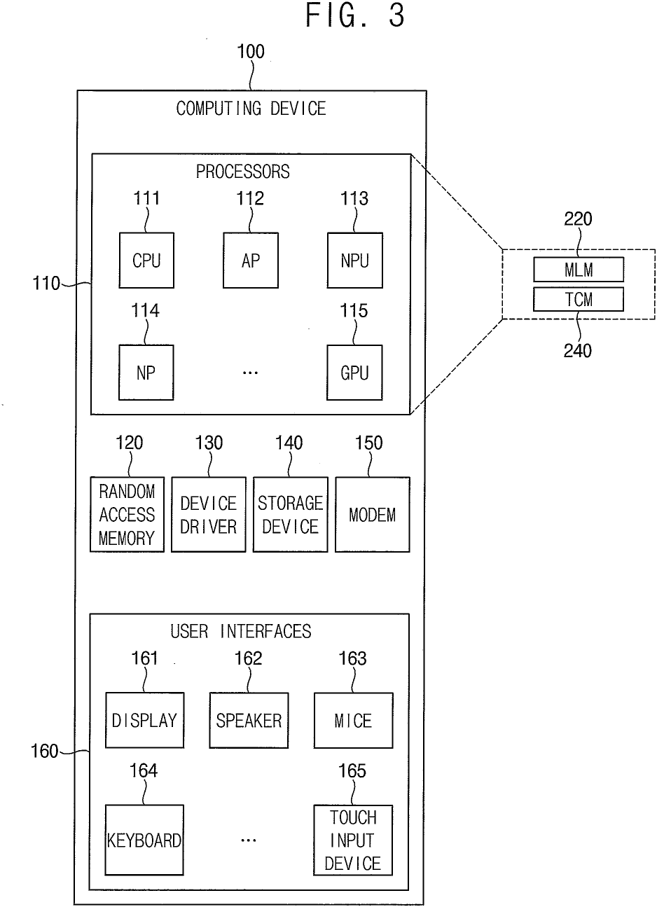

FIG. 3 is a block diagram illustrating a computing device according to example embodiments.

Referring to FIG. 3, a computing device 100 may include processors 110, a random access memory 120, a device driver 130, a storage device 140, a modem 150, and user interfaces 160.

At least one processor of the processors 110 may be configured to operate a machine learning model (or a deep learning model) MLM 220 and a training control module TCM 240. The training control module 240 may control the machine learning model MLM based on the decrypted data DD as described with reference to FIGS. 1 and 2.

In some example embodiments, the machine learning model 220 and the training control module 240 may be implemented as instructions (and/or program codes) that may be executed by the at least one of the processors 110. The instructions (and/or program codes) of the machine learning model 220 and the training control module 240 may be stored in computer readable media. For example, the at least one processor may load (and/or read) the instructions to (and/or from) the random access memory 120 and/or the storage device 140.

In some example embodiments, the at least one processor may be manufactured to efficiently execute instructions included in the machine learning model 220 and the training control module 240. For example, the at least one processor may be a dedicated processor that is implemented (e.g., in hardware) based on the machine learning model 220 and the training control module 240. The at least one processor may efficiently execute instructions from various machine learning modules. In some example embodiments, the at least one processor may receive information corresponding to the machine learning model 220 and the training control module 240 to operate the machine learning model 220 and the training control module 240.

The processors 110 may include, for example, at least one general-purpose processor such as a central processing unit (CPU) 111, an application processor (AP) 112, and/or other processing units. In addition, the processors 110 may include at least one special-purpose processor such as a neural processing unit (NPU) 113, a neuromorphic processor (NP) 114, a graphic processing unit (GPU) 115, etc. For example, the processors 110 may include two or more heterogeneous processors. Though the processors 110 are illustrated as including the CPU 111, AP 112, NPU 113, NP 114, and GPU 115, example embodiments are not so limited. For example, the processors 110 may include more or fewer processors than illustrated.

The random access memory 120 may be used as an operation memory of the processors 110, a main memory, and/or a system memory of the computing device 100. The random access memory 120 may include a volatile memory such as a dynamic random access memory (DRAM), a static random access memory (SRAM), and/or the like. Additionally (and/or alternatively), the random access memory 120 may include a nonvolatile memory such as a phase-change random access memory (PRAM), a ferroelectrics random access memory (FRAM), a magnetic random access memory (MRAM), a resistive random access memory (RRAM), and/or the like.

The device driver 130 may control peripheral circuits such as the storage device 140, the modem 150, the user interfaces 160, etc., according to requests of the processors 110. The storage device 140 may include a fixed storage device such as a hard disk drive, a solid state drive (SSD), etc., and/or include (and/or be connected to) an attachable storage device such as an external hard disk drive, an external SSD, a memory card, and/or other external storage.

The modem 150 may perform wired and/or wireless communication with external devices through various communication methods and/or communication interface protocols such as Ethernet, WiFi, LTE, a third generation communication system such as code division multiple access (CDMA), global system for mobile communications (GSM), north American digital cellular (NADC), extended-time division multiple access (E-TDMA), and/or wide band code division multiple access (WCDMA), a fourth generation communication system such as 4G LTE, a fifth generation communication system such as 5G mobile communication, and/or other communication methods.

The user interfaces 160 may receive information from a user and provide information to the user. The user interfaces 160 may include at least one output interface such as a display 161, a speaker 162, etc., and may further include at least one input interface such as mice (or a mouse) 163, a keyboard 164, a touch input device 165, etc. Though illustrated as including the display 161, the speaker 162, the mice 163, the keyboard 164, and the touch input device 165, example embodiments are not so limited, and may, e.g., include more or fewer elements. In some example embodiments, for example, some of the user interfaces 160 may be combined (e.g., to include a touch screen and/or the like). In some example embodiments, for example, the user interfaces 160 may include connection ports or wireless interfaces to connect external devices, such as an external display, an external speaker, an external mouse, and external keyboard and an external touch input device.

In some example embodiments, the machine learning model 220 and the training control module 240 may receive the instructions (and/or program codes) through the modem 150 and store the instructions in the storage device 140. In some example embodiments, the instructions of the machine learning model 220 and the training control module 240 may be stored in an attachable storage device and the attachable storage device may be connected to the computing device 100 by a user. The instructions of the machine learning model 220 and the training control module 240 may be loaded in the random access memory 120 for rapid execution of the instructions.

In some example embodiments, at least one of the computer program codes, the machine learning model and/or the training control module may be stored in a transitory and/or non-transitory computer-readable medium. In some example embodiments, values resulting from a simulation performed by the processor and/or values obtained from arithmetic processing performed by the processor may be stored in a transitory and/or non-transitory computer-readable medium. In some example embodiments, intermediate values generated during machine learning may be stored in a transitory and/or non-transitory computer-readable medium. In some example embodiments, at least one of the training data, the process data, the device data, the simulation result data, the prediction current-voltage curve, and/or the uncertainty data may be stored in a transitory and/or non-transitory computer-readable medium. However, example embodiments are not limited thereto.

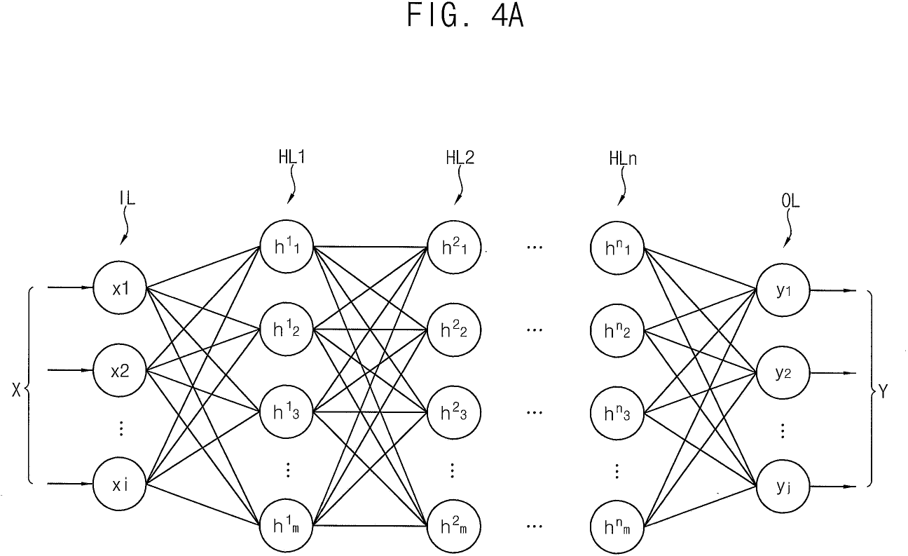

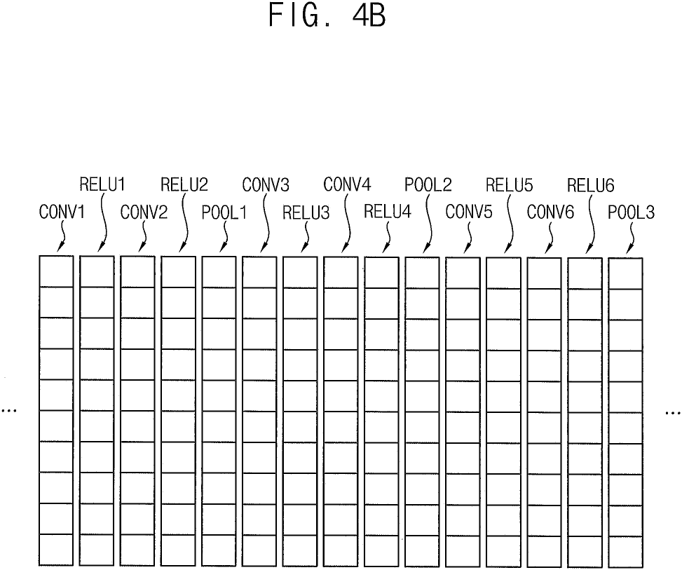

FIGS. 4A and 4B are diagrams for describing examples of a neural network structure that is driven by a machine learning device according to example embodiments.

Referring to FIG. 4A, a general neural network may include an input layer IL, a plurality of hidden layers HL1, HL2, ..., HLn and an output layer OL.

The input layer IL may include i input nodes x1, x2, ..., xi, where i is a natural number. Input data (e.g., vector input data) X whose length is i may be input to the input nodes x1, x2, ..., xi such that each element of the input data X is input to a respective one of the input nodes x1, x2, ..., xi.

The plurality of hidden layers HL1, HL2, ..., HLn may include n hidden layers, where n is a natural number, and may include a plurality of hidden nodes

$${\text{h}}^{1} {}_{1} , {\text{h}}^{1} {}_{2} , {\text{h}}^{1} {}_{3} , … , {\text{h}}^{1} {}_{\text{m}} , {\text{h}}^{2} {}_{1} ,$$

For example, the hidden layer HL1 may include m hidden nodes

$${\text{h}}^{1} {}_{1} , {\text{h}}^{1} {}_{2} , {\text{h}}^{1} {}_{3} , … , {\text{h}}^{1} {}_{\text{m}} ,$$

the hidden layer HL2 may include m hidden nodes

$${\text{h}}^{2} {}_{1} , {\text{h}}^{2} {}_{2} , {\text{h}}^{2} {}_{3} , … , {\text{h}}^{2} {}_{\text{m}} ,$$

and the hidden layer HLn may include m hidden nodes

$${\text{h}}^{\text{n}} {}_{1} , {\text{h}}^{\text{n}} {}_{2} , {\text{h}}^{\text{n}} {}_{3} , … , {\text{h}}^{\text{n}} {}_{\text{m}} ,$$

where m is a natural number.

The output layer OL may include j output nodes y1, y2, ..., yj, providing output data Y where j is a natural number. The output layer OL may output the output data Y associated with the input data X.

A structure of the neural network illustrated in FIG. 4A may be represented by information on branches (or connections) between nodes illustrated as lines, and a weighted value assigned to each branch. Nodes within one layer may not be connected to one another, but nodes of different layers may be fully (and/or partially) connected to one another.

Each node (e.g., the node

$$\left({\text{h}}^{1} {}_{1}\right)$$

may receive an output of a previous node (e.g., the node x₁), may perform a computing operation, computation and/or calculation on the received output, and may output a result of the computing operation, computation, or calculation as an output to a next node (e.g., the node

$$\left({\text{h}}^{2} {}_{1}\right) .$$

Each node may calculate a value to be output by applying the input to a specific function, e.g., a nonlinear function.

Generally, the structure of the neural network may be set in advance, and the weighted values for the connections between the nodes are set appropriately using data having a known answer of which class the data belongs to. The data with the known answer may be referred to as “training data,” and a process of determining the weighted values is referred to as “training.” The neural network “learns” during the training process. A group of an independently trainable structure and the weighted values is referred to as a “model,” and a process of predicting, by the model with the determined weighted value, which class the input data belongs to, and then outputting the predicted value, is referred to as a “testing” process.

The general neural network illustrated in FIG. 4A may not be suitable for and/or inefficient for some operations, such as handling input image data (or input sound data), because each node (e.g., the node

$$\left({\text{h}}^{1} {}_{1}\right)$$

is connected to all nodes of a previous layer (e.g., the nodes x1, x2, ..., xi included in the layer IL) and then the number of weighted values drastically increases as the size of the input image data increases. Thus, a convolutional neural network (CNN), which is implemented by combining the filtering technique with the general neural network, has been researched such that two-dimensional image data (e.g., the input image data) is efficiently trained by the convolutional neural network.

Referring to FIG. 4B, a convolutional neural network may include a plurality of layers CONV1, RELU1, CONV2, RELU2, POOL1, CONV3, RELU3, CONV4, RELU4, POOL2, CONV5, RELU5, CONV6, RELU6, POOL3 and FC.

Unlike the general neural network, each layer of the convolutional neural network may have three dimensions of width, height, and depth, and thus data that is input to each layer may be volume data having three dimensions of width, height, and depth.

Each of convolutional layers CONV1, CONV2, CONV3, CONV4, CONV5 and CONV6 may perform a convolutional operation on input volume data. In an image processing, the convolutional operation represents an operation in which image data is processed based on a mask with weighted values, and an output value is obtained by multiplying input values by the weighted values and adding up the total multiplied values. The mask may be referred to as a filter, window, and/or kernel.

For example, parameters of each convolutional layer may include a set of learnable filters. Every filter may be spatially small (e.g., along width and height dimensions), but may extend through the full depth of an input volume. For example, during a forward pass, each filter may be slid (e.g., convolved) across the width and height of the input volume, and dot products may be computed between the entries of the filter and the input at any position. As the filter is slid over the width and height of the input volume, a two-dimensional activation map that gives the responses of that filter at every spatial position may be generated. As a result, an output volume may be generated by stacking these activation maps along the depth dimension. For example, if input volume data having a size of 32×32×3 passes through the convolutional layer CONV1 having four filters with zero-padding, output volume data of the convolutional layer CONV1 may have a size of 32×32×12 (e.g., a depth of volume data increases).

Each of the rectifying linear unit (“RELU”) layers RELU1, RELU2, RELU3, RELU4, RELU5 and RELU6 may perform a rectified linear unit operation that corresponds to an activation function defined by, e.g., a function f(x)=max(0, x) (e.g., an output is zero for all negative input x). For example, if input volume data having a size of 32×32×12 passes through the RELU layer RELU1 to perform the rectified linear unit operation, output volume data of the RELU layer RELU1 may have a size of 32×32×12 (e.g., a size of volume data is maintained).

Each of pooling layers POOL1, POOL2 and POOL3 may perform a down-sampling operation on input volume data along spatial dimensions of width and height. For example, four input values arranged in a 2×2 matrix formation may be converted into one output value based on a 2×2 filter. For example, a maximum value of four input values arranged in a 2×2 matrix formation may be selected based on 2×2 maximum pooling, or an average value of four input values arranged in a 2×2 matrix formation may be obtained based on 2×2 average pooling. For example, if input volume data having a size of 32×32×12 passes through the pooling layer POOL1 having a 2×2 filter, output volume data of the pooling layer POOL1 may have a size of 16×16×12 (e.g., width and height of volume data decreases, and a depth of volume data is maintained).

Typically, one convolutional layer (e.g., CONV1) and one RELU layer (e.g., RELU1) may form a pair of CONV/RELU layers in the convolutional neural network, pairs of the CONV/RELU layers may be repeatedly arranged in the convolutional neural network, and the pooling layer may be periodically inserted in the convolutional neural network, thereby reducing characteristics of the input data X. The type and number of layers including in the convolution neural network may be changed variously.

Example embodiments of the deep learning model or machine learning models are not limited to a specific neural network. The deep learning model may include, for example, at least one of Generative Adversarial Network (GAN), Convolution Neural Network (CNN), Region with Convolution Neural Network (R-CNN), Region Proposal Network (RPN), Recurrent Neural Network (RNN), Stacking-based deep Neural Network (S-DNN), State-Space Dynamic Neural Network (S-SDNN), Deconvolution Network, Deep Belief Network (DBN), Restricted Boltzmann Machine (RBM), Fully Convolutional Network, Long Short-Term Memory (LSTM) Network, Classification Network and Bayesian Neural Network (BNN). Additionally (and/or alternatively), the deep learning model(s) may be trained based on at least one of various algorithms such as regression, linear and/or logistic regression, random forest, a SVM (support vector machine), and/or other types of models, such as statistical clustering, Bayesian classification, decision trees, dimensionality reduction such as principal component analysis, expert systems, and/or combinations thereof including ensembles such as random forests.

FIG. 4C is a diagram illustrating an example of a node included in a neural network.

FIG. 4C illustrates an example node operation performed by a node ND in a neural network. When N inputs al~an are provided to the node ND, the node ND may multiply the n inputs a1~an and corresponding n weights wl~wn, respectively, may sum n values obtained by the multiplication, may add an offset “b” to a summed value, and may generate one output value by applying a value to which the offset “b” is added to a specific function “σ”. The learning operation may be performed based on the training data to update all nodes in the neural network.

In cases of prediction of the characteristics of a semiconductor device based on deep learning, a sufficient amount of training data and/or learning data may be utilized in (and/or required for) training of a deep learning model and/or deep learning module. For example, tens through millions of training data of various kinds may be utilized in (and/or required for) preventing over-fitting during training and enhance performance of the deep learning model. According to some example embodiments, security of data used in training and/or inference may be reinforced by controlling the machine learning model based on the functional encryption using the LWE problem and the lattice problem.

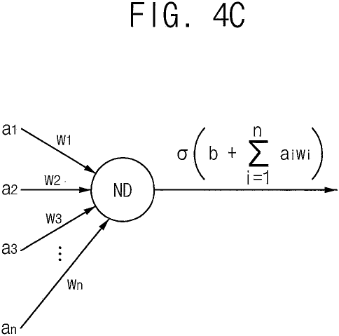

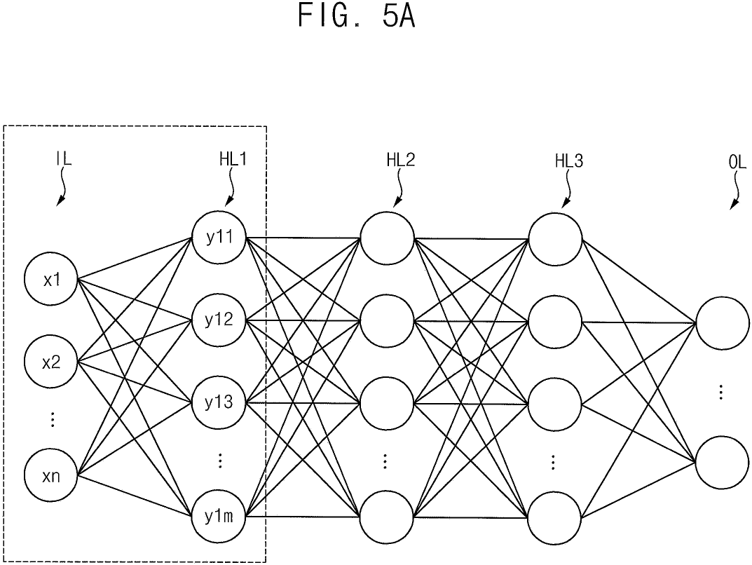

FIG. 5A is a diagram illustrating machine learning based on input data, and FIG. 5B is a diagram illustrating machine learning based on decrypted data generated by a method of controlling a machine learning model according to example embodiments.

Referring to FIGS. 5A and 5B, a machine learning model may include an input layer IL, a plurality of hidden layers HL1~HL3 and an output layer OL. FIGS. 5A and 5B illustrate three hidden layers, that is, a first hidden layer HL1, a second hidden layer HL2 and a third hidden layer HL3 for convenience of illustration, and the machine learning model may include various number of hidden layers as described with reference to FIGS. 4A, 4B and 4C.

Referring to FIG. 5A, the input layer IL may include n input nodes receiving n input data x1~xn, respectively, and the first hidden layer HL1 may include m hidden nodes. The m hidden nodes in the first hidden layer HL1 may receive the n input data x1~xn from the input layer, and transfer m node output values y11~y1m to the second hidden layer HL2, where the m node output values are results of node operations as described with reference to FIG. 4C.

FIG. 5B illustrates a decryption device DECD corresponding to the input layer IL and the first hidden layer HL1 in FIG. 5A. The decryption device DECD may receive m encrypted data c1~cm and m secret keys skh1~skhm, and transfer m node output values y11′~y1m′ corresponding to m hidden nodes in the first hidden layer HL1 to the second hidden layer HL2 by decrypting the m encrypted data c1~cm based on the m secret keys skh1~skm. Here, the m node output values correspond to the above-mentioned decrypted data DD, and each node output value y1j′ (j=1~m) corresponds to the approximation value of the inner product of the parameter vector and the input vector of the corresponding hidden node.

As such, the machine learning engine MLE in FIG. 1 may control the machine learning model MLM based on the decrypted data y11′~y1m′ in FIG. 5B, rather than the input data x1~xm in FIG. 5A. As illustrated in 5B, the machine learning engine MLE may apply the decrypted data y11′~y1m′ as inputs of the second hidden layer HL2.

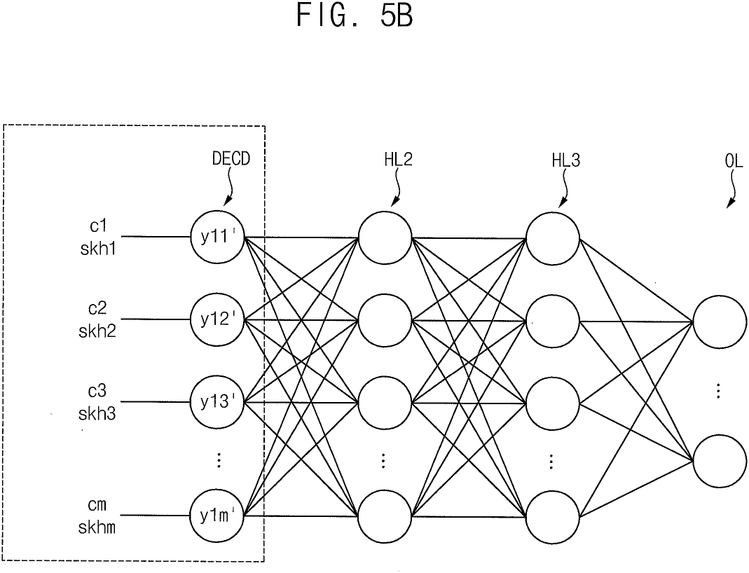

Hereinafter, example configuration and operation of the key generation device KGD, the encryption device ENC and the decryption device DECD are described with reference to FIGS. 6, 7 and 8 using an example in which the first hidden layer HL1 includes the m hidden nodes.

FIG. 6 is a block diagram illustrating a key generation device included in a system according to example embodiments.

Referring to FIG. 6, the key generation device KGD may include m generation units GU1~GUm respectively corresponding to the m hidden nodes in the first hidden layer HL1.

Each generation unit GUj (j=1~m) may generate each public key vector pkhj and each secret key vector skhj based on the master key msk and each node parameter vector hj.

As such, the above-mentioned parameter vector h may include the m node parameter vectors h1~hm respectively corresponding to m hidden nodes in the first hidden layer HL1, the above-mentioned secret key skh may include the m secret key vectors skh1~skhm respectively corresponding to the m hidden nodes, and the above-mentioned public key pkh may include the m public key vectors pkh1~pkhm respectively corresponding to the m hidden nodes.

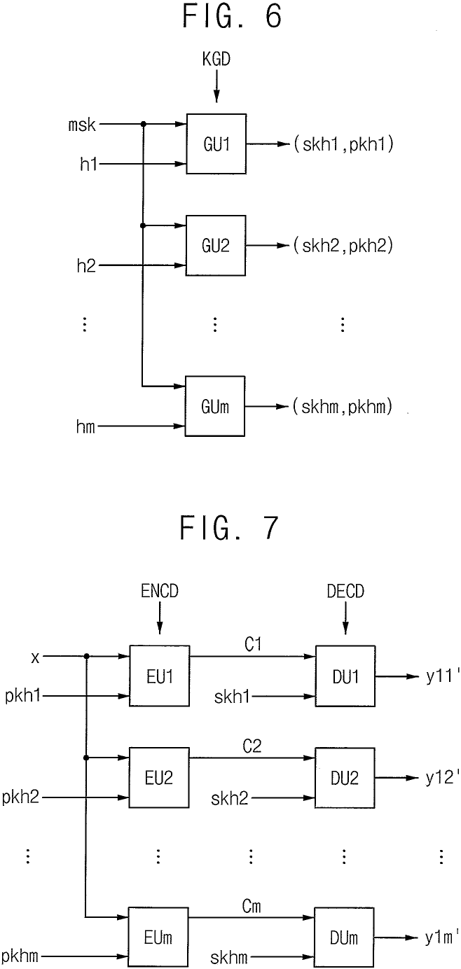

FIG. 7 is a block diagram illustrating an encryption device and a decryption device included in a system according to example embodiments.

Referring to FIG. 7, the encryption device ENCD may include m encryption units EU1~EUm respectively corresponding to the m hidden nodes in the first hidden layer HL1, and the decryption device DECD may include m decryption units DU1~DUm respectively corresponding to the m hidden nodes in the first hidden layer HL1,

Each encryption unit EUj (j=1~m) may generate each node encrypted data cj by encrypting the input vector x based on each public key pkhj. Each decryption unit DUj may generate each node output value ylj’ by decrypting each node encrypted data cj based on each secret key vector skhj. Each node output value ylj’ may indicate an approximation value of an inner product of each parameter vector hj and the input vector x.

As such, the above-mentioned encrypted data DE may include the m node encrypted data c1~cm respectively corresponding to the m hidden nodes in the first hidden layer HL1, and the above-mentioned decrypted data DD may include the m node output values y11′~y1m′ respectively corresponding to the m hidden nodes.

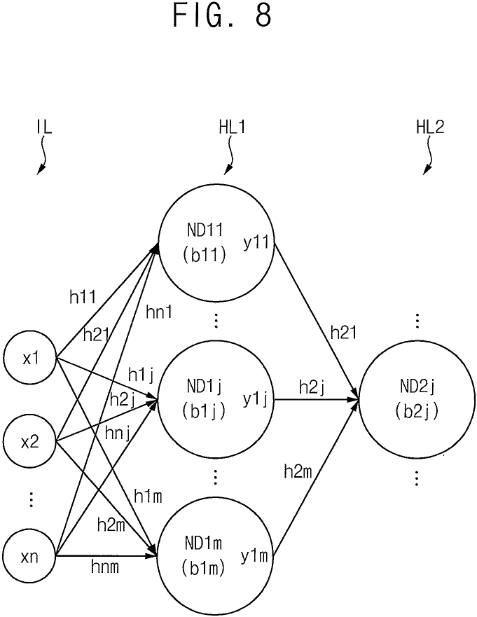

FIG. 8 is a diagram for describing a node operation by a hidden node in a first hidden layer according to example embodiments.

FIG. 8 illustrates a portion of the machine learning model for convenience of illustration. The input layer IL may receive n input values x1~xn, and the first hidden layer HL1 may include m hidden nodes ND11~ND1m.

Each hidden node ND1j (j=1~m) may perform a node operation based on n input values x1~xn, n weight values h1j~hnj and a bias value bj, and output each node output value ylj as Expression 1.

$$y 1 j = {\sum }_{k} x t ⋅ h i j + b j = < x , h j >$$

In Expression 1, <x, hj> indicates an inner product of the input vector x and each node parameter vector hj. For the node operation reflecting the weight values h1j~hmj and the bias value bj of the hidden node ND1j, the input vector x and the node parameter vector hj may generated as Expression 2 and Expression 3.

$$\text{x=} \left(1 , \text{x1,} \text{x2,} ⋯ \text{,} \text{xn}\right)$$

$$\text{hj=} \left(\text{bj, w1j, w2j,} ⋯ \text{, wnj}\right)$$

In Expression 2 and Expression 3, x indicates the input vector, x1 through xn indicate input values of the input vector, hj indicates a node parameter vector corresponding to a j-th hidden node ND1j in the first hidden layer HL1, bj indicates a bias value corresponding to the j-th hidden node ND1j, and wlj through wnj indicate weight values corresponding to the j-th hidden node ND1j .

The m node output values y11~y1m from the first hidden layer HL1 may be transferred to each hidden node ND2j in the second hidden layer HL2. Each hidden node ND2j in the second hidden layer HL2 may perform a node operation based on the node output values y11-y1m from the first hidden layer HL1, the weight values h21~j2m and the bias value b2j.

The learning with error (LWE) problem is a computational problem in inferring a q-ary function f from a finite ring from given samples of Yi=f(xi). The LWE problem may be designed to be solved difficultly for encryption. The lattice problem is an optimization problem associated mathematical objects called lattices. The lattice problem is one of Non-deterministic Polynomial-time hardness (NP) problem, and the lattice problem may include shortest vector problem (SVP), closest vector problem (CVP), and so on.

Hereinafter, example embodiments of functional encryption using the LWE problem and the lattice problem are described with reference to FIGS. 9A, 9B and 9C.

FIG. 9A is a flow chart illustrating key generation in a method of controlling a machine learning model according to example embodiments.

Referring to FIGS. 1 and 9A, the key generation device 11 may receive the parameter vector h from an external device (S11). In some example embodiments, the parameter vector h may indicate parameters of a first hidden layer of the machine learning model MLM, and the key generation device 11 may receive the parameter vector h from the machine learning engine MLE controlling the machine learning model MLM.

The key generation device 11 may determine the master key msk (S12). In some example embodiments, the key generation device 11 may determine the master key msk based on Expression 4.

$$\begin{matrix}u ← {ℤ}_{q}^{n} , A ← {ℤ}_{q}^{n \times n} \\ {u}^{T} ⋅ A = {μ}^{T} , \left|μ\right| < L \\ \text{msk =} u\end{matrix}$$

In Expression 4, with respect to ring of integers ℤ_{q},

$${ℤ}_{q}^{n}$$

indicates a set of n×1

$${ℤ}_{q}^{n}$$

$${ℤ}_{q}^{n \times n}$$

matrices, and indicates a set of n×n matrices. Accordingly, u is an n×1 vector and A is an n×n matrix.

The key generation device 11 may determine the vector u satisfying u^{T} • A = µ^{T} as the master key msk, with respect to an n× 1 random vector µ such that the norm of µ is smaller than L, that is, satisfying |µ|< L. Here, A is an invertible matrix, U^{T} and µ^{T} indicate transpose matrices of u and µ and thus U^{T} and µ^{T} are 1× n vectors.

The key generation device 11 may select random vectors s, e and f (S13) as Expression 5.

$$\begin{matrix}\text{Q =} \left\{\left(r\right| \left|r\right| \leq B\right\} \\ s , e , f ← \text{Q}\end{matrix}$$

In Expression 5, Q indicates a set of n × 1 vectors r such that the norm of r is smaller than B, that is, satisfying |r|≤ B. The random vectors s, e and f may be selected from Q.

The key generation device 11 may determine an encrypted parameter vector v (S14) as Expression 6.

$$v = s - {\left(A\right)}^{- 1} ⋅ N h - u$$

The key generation device 11 may perform a matrix operation of an inverse matrix (A)-1 and an vector Nh where the vector Nh is a multiplication of an error factor value N and the parameter vector h, and determine the encrypted parameter vector v using the random vector s and the vector u corresponding to the master key msk.

The key generation device 11 may generate the secret key skh and the public key pkh based on the encrypted parameter vector v, the matrix A and the random vectors s, e and f based on Expression 7.

$$\begin{matrix}\left(s k h , p k h\right) = \left(s , \left(p k 1 , p k 2 , p k 2\right)\right) \\ p k 1 = A ⋅ s + e , \\ p k 2 = A , \\ p k 3 = A ⋅ v + f\end{matrix}$$

As represented by Expression 7, the secret key skh may be the random vector s, the public key pkh may include a first key pk1 corresponding to a vector As+e, a second key pk2 corresponding to the matrix A, and a third key pk3 corresponding to a vector Av+f.

FIG. 9B is a flow chart illustrating encryption in a method of controlling a machine learning model according to example embodiments.

Referring to FIGS. 1 and 9B, the encryption device 12 may receive the public key pkh and the input vector x (S21). The encryption device 12 may receive the public key pkh from the key generation device 11 and the input vector x from an external device.

The encryption device 12 may select random vectors w, e″ and random values e′ and e‴ (S22) as Expression 8.

$$\begin{matrix}\text{Q =} \left\{\left(r\right| \left|r\right| \leq B\right\} \\ {\text{Q}}_{1} \text{=} \left\{\left({r}_{1}\right| \left|{r}_{1}\right| \leq M\right\} \\ w , {e}^{″} ← \text{Q} \\ {e}^{′} , {e}^{‴} ← {\text{Q}}_{1}\end{matrix}$$

In Expression 8, Q indicates the set of n×1 vectors r such that the norm of r is smaller than B, that is, satisfying |r|≤ B, and Q₁ indicates a set of values such that each absolute value is smaller than M. The random vectors w and e″ may be selected from Q and the random values e′ and e‴ may be selected from Q₁.

The encryption device 12 may generate the encrypted data DE based on the first key pk1, the second key pk2 and the third key pk3, which correspond to the public key pkh (S23), as Expression 9.

$$\begin{matrix}D E = \left({C}_{1} , {C}_{2} , {C}_{3}\right) \\ C 1 = p k {1}^{T} ⋅ w + {e}^{′} \\ C 2 = p k 2 ⋅ \left(x + w\right) + {e}^{″} \\ C 3 = p k {3}^{T} ⋅ x + {e}^{‴}\end{matrix}$$

As represented by Expression 9, the encrypted data DE may include first data C1 corresponding to a value (that is, a scalar value)

$${\text{pk}}_{1}^{T} ⋅ w + {e}^{′} ,$$

a second data C2 corresponding to a vector

$${\text{pk}}_{2} ⋅ \left(x + w\right) + {e}^{″} ,$$

and a third data C3 corresponding to a value

$${\text{pk}}_{3}^{T} ⋅ x + {e}^{‴} .$$

FIG. 9C is a flow chart illustrating decryption in a method of controlling a machine learning model according to example embodiments.

Referring to FIGS. 1 and 9C, the decryption device 13 may receive the secret key skh and the encrypted data DE (S31). The decryption device 13 may receive the secret key skh from the key generation device 11 and the encrypted data DE from the encryption device 12.

The decryption device 13 may generate the decrypted data DD by decrypting the first data C1, the second data C2 and the third data C3, which are corresponding to the encrypted data DE based on the secret key skh (S32), as Expression 10.

$$\begin{matrix}D D = \frac{1}{N} ⋅ \left(s k {h}^{T} ⋅ {C}_{2} - {C}_{1} - {C}_{3}\right) = {h}^{T} ⋅ x + E \\ \approx {h}^{T} ⋅ x\end{matrix}$$

As a result, as shown in Expression 10, the decrypted data DD may be represented by a sum of the inner product h^{T} • x of the parameter vector h and the input vector x and an inner product error value E. The inner product error value is calculated as Expression 11.

$$\left|E\right| = \frac{1}{N} \left|{\left(μ - f\right)}^{T} ⋅ x + {s}^{T} ⋅ {e}^{″} + {e}^{T} ⋅ w + {e}^{′} - {e}^{‴}\right|$$

As shown in Expression 11, the inner product error value E may be represented by the error factor value N, the input vector x, the random vectors µ, f, s, e″, e and w, and the random values e′ and e‴. The absolute value of the inner product error value E may be decreased and the decrypted data DD may approach the inner product h^{T} • x, as the error factor values N is increased.

As described with reference to FIGS. 5A through 8, the parameter vector h may include the plurality of node parameter vectors h1~hm respectively corresponding to the hidden nodes in the first hidden layer HL1. The functional encryption as described with reference to FIGS. 9A, 9B and 9C may be applied to each node parameter vector hj (j=1~m) to generate each secret key vector skhj, each public key vector pkhj, each node encrypted data cj and each node output value y1j′.

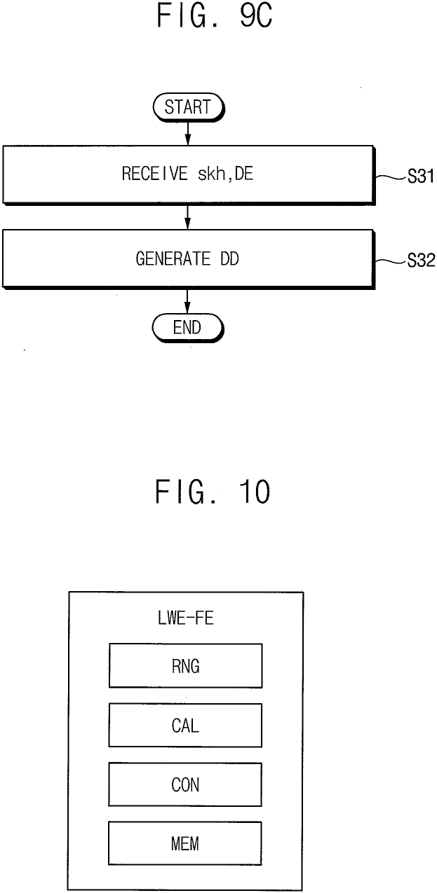

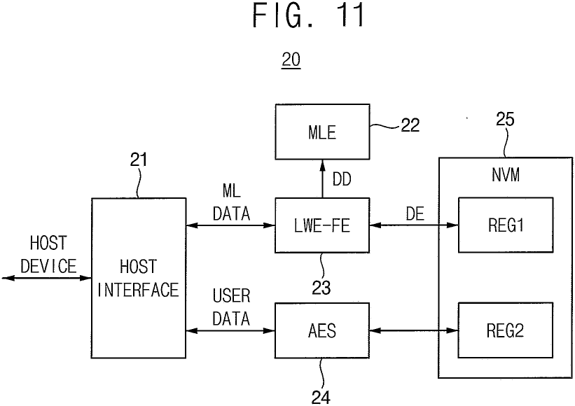

FIG. 10 is a block diagram illustrating a learning with error (LWE) device included in a system according to example embodiments.

Referring to FIG. 10, an LWE-FE (Learning With Error Functional Encryption) device may include a random number generator RNG, an operation circuit CAL, a controller CON and a memory MEM.

The random number generator RNG may provide random numbers to the controller CON, and the controller CON may generate the random numbers and the random vectors for the functional encryption as described with reference to FIGS. 9A, 9B and 9C.

The operation circuit CAL may perform operations such as addition, subtraction, multiplication, matrix operation. Here the matrix may include the n×1 vector and the 1×n vector. In some example embodiments, the operation circuit CAL may include a Chinese Remainder Theorem (CRT) operator and perform q-ary operation using the CRT operator.

The LWE-FE device may be implemented to perform all or a portion of the functions of the key generation device 11, the encryption device 12 and the decryption device 13. When the LWE-FE performs all functions of the devices 11, 12 and 13, at least a portion of the random number generator RNG, the operation circuit CAL, the controller CON and the memory MEM may be common resources shared by the devices 11, 12 and 13.

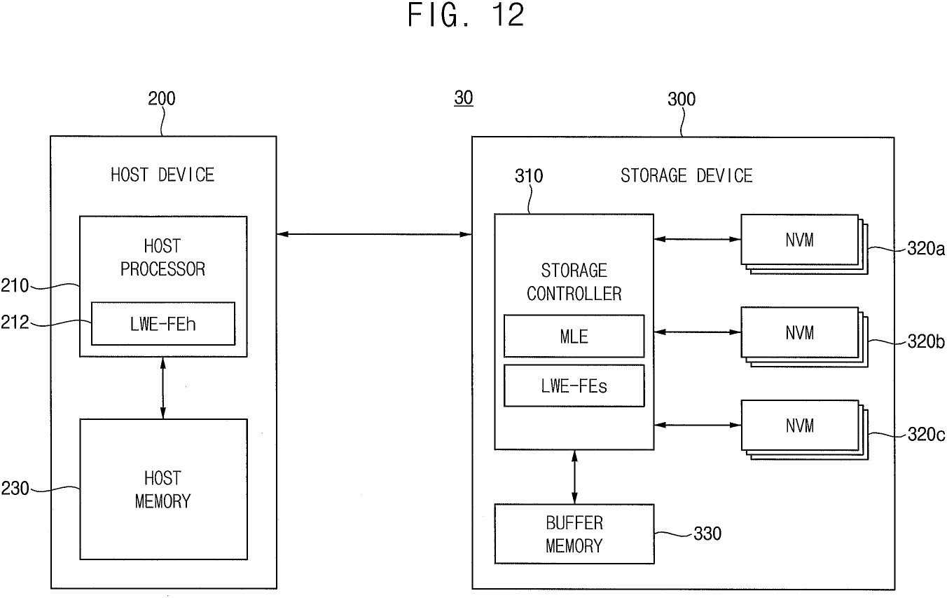

FIG. 11 is a block diagram illustrating a system according to example embodiments.

Referring to FIG. 11, a system 20 may include a host interface 21, a machine learning engine MLE 22, a first security device 23, a second security device AES (24) and a nonvolatile memory device NVM 25.

The host interface 21 may perform communication with an external host device. The machine learning engine 22 may receive the decrypted data DD, rather than the machine learning data (ML DATA), and control a machine learning model based on the decrypted data DD.

The system 20 may perform different security policies depending on characteristics of data stored in the nonvolatile memory device 25.

The first security device 23 may perform encryption and decryption based on LWE-FE as described above. When the machine learning (ML) data are received through the host interface 21, the first security device 23 may generate encrypted data DE by encrypting the machine learning date and store the encrypted data DE in a first region REG1 of the nonvolatile memory device 25. According to example embodiments, the encrypted data DE may be received through the host interface 21, and the encrypted data DE may be stored directly in the nonvolatile memory device 25 without processing. The first security device 23 may read the encrypted data DE from the nonvolatile memory device 25 and decrypt the encrypted data DE to provide the decrypted data DD to the machine learning engine 22.

When the user data are received through the host interface 21, the second security device 24 may encrypt the user data, for example, based on Advanced Encryption Standard (AES) algorithm and store the encrypted user data in a second region REG2 of the nonvolatile memory device 25. The second security device 24 may read the encrypted user data from the nonvolatile memory device 25 and decrypt the encrypted user data to provide the decrypted user data to the host interface 21. According to example embodiments, the second security device 24 may transfer the encrypted user data to the host device and the host device may decrypt the encrypted user data.

FIG. 12 is a block diagram illustrating a storage system including a storage device according to example embodiments.

Referring to FIG. 12, a storage system 30 includes a host device 200 and a storage device 300.

The host device 200 controls overall operations of the storage system 100. The host device 200 may include a host processor 210 and a host memory 230.

The host processor 210 may control an operation of the host device 200. For example, the host processor 210 may execute an operating system (OS). For example, the operating system may include a file system for file management and a device driver for controlling peripheral devices, including the storage device 300 at the operating system level. For example, the host processor 210 may include at least one of various processing units, e.g., a central processing unit (CPU), or the like.

The host memory 230 may store instructions and/or data that are executed and/or processed by the host processor 210. For example, the host memory 230 may include at least one of various volatile memories, e.g., a dynamic random access memory (DRAM), or the like.

The storage device 300 is accessed by, that is, communicably coupled to the host device 200. The storage device 300 may include a storage controller 310, a plurality of nonvolatile memories 320a, 320b and 320c, and a buffer memory 330.

The storage controller 310 may control an operation of the storage device 300, e.g., a data write operation and/or a data read operation, based on a command and data that are received from the host device 200.

The storage system 30 may generate a public key and a secret key based on a master key and a parameter vector indicating parameters of a first hidden layer of the machine learning model, generate encrypted data by encrypting, based on the public key, an input vector indicating input data of the machine learning model, generate decrypted data corresponding to an approximation value of an inner product of the parameter vector and the input vector by decrypting the encrypted data based on the secret key, and control the machine learning model based on the decrypted data.

To realize such functional encryption, the storage controller 310 may include a storage functional encryption device LWE-FEs and the host device 200 may include a host functional encryption device LWE-FEh 212. Even though FIG. 12 illustrates that the host functional encryption device LWE-FEh is included in the host processor 210, example embodiments are not limited thereto and the host functional encryption device LWE-FEh may be implemented as an independent processing circuit distinct from the host processor 210. In some example embodiments, the host functional encryption device LWE-FEh may be omitted.

The storage controller 310 may include a machine learning engine MLE. As described above, the storage functional encryption device LWE-FEs may provide the decrypted data to the machine learning model, and the machine learning engine MLE may control the machine learning model based on the decrypted data.

The plurality of nonvolatile memories 320a, 320b and 320c may store a plurality of data. For example, the plurality of nonvolatile memories 320a, 320b and 320c may store the meta data, various user data, or the like.

In some example embodiments, each of the plurality of nonvolatile memories 320a, 320b and 320c may include a NAND flash memory. In other example embodiments, each of the plurality of nonvolatile memories 320a, 320b and 320c may include one of an electrically erasable programmable read only memory (EEPROM), a phase change random access memory (PRAM), a resistance random access memory (RRAM), a nano floating gate memory (NFGM), a polymer random access memory (PoRAM), a magnetic random access memory (MRAM), a ferroelectric random access memory (FRAM), a thyristor random access memory (TRAM), or the like.

The buffer memory 330 may store instructions and/or data that are executed and/or processed by the storage controller 310, and may temporarily store data stored in or to be stored into the plurality of nonvolatile memories 320a, 320b and 320c. For example, the buffer memory 330 may include at least one of various volatile memories, e.g., a static random access memory (SRAM), a DRAM, or the like.

In some example embodiments, the storage device 300 may be a universal flash storage (UFS). In other example embodiments, the storage device 300 may be a solid state drive (SSD), a multi-media card (MMC) or an embedded multi-media card (eMMC). In still other example embodiments, the storage device 300 may be one of a secure digital (SD) card, a micro SD card, a memory stick, a chip card, a universal serial bus (USB) card, a smart card, a compact flash (CF) card, or the like.

In some example embodiments, the storage device 300 may be connected to the host device 200 via a block accessible interface which may include, for example, a UFS, an eMMC, a serial advanced technology attachment (SATA) bus, a nonvolatile memory express (NVMe) bus, a serial attached SCSI (SAS) bus, or the like. The storage device 300 may use a block accessible address space corresponding to an access size of the plurality of nonvolatile memories 320a, 320b and 320c to provide the block accessible interface to the host device 200, for allowing the access by units of a memory block with respect to data stored in the plurality of nonvolatile memories 320a, 320b and 320c.

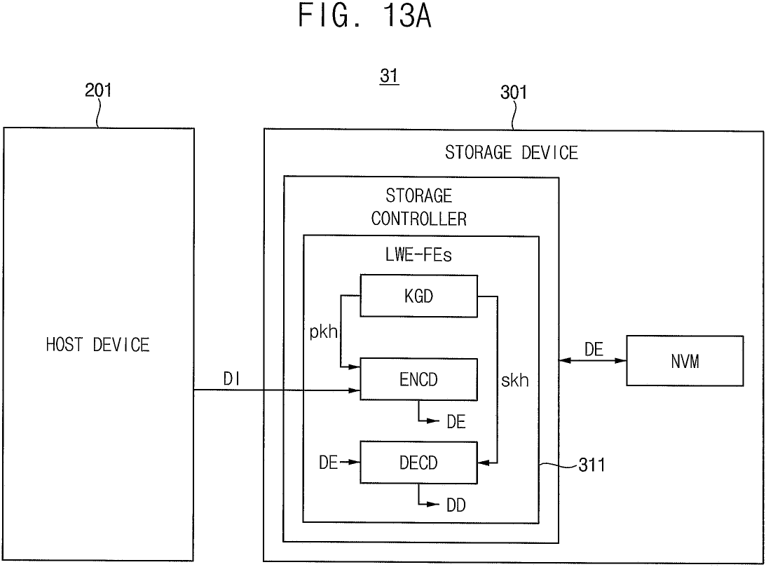

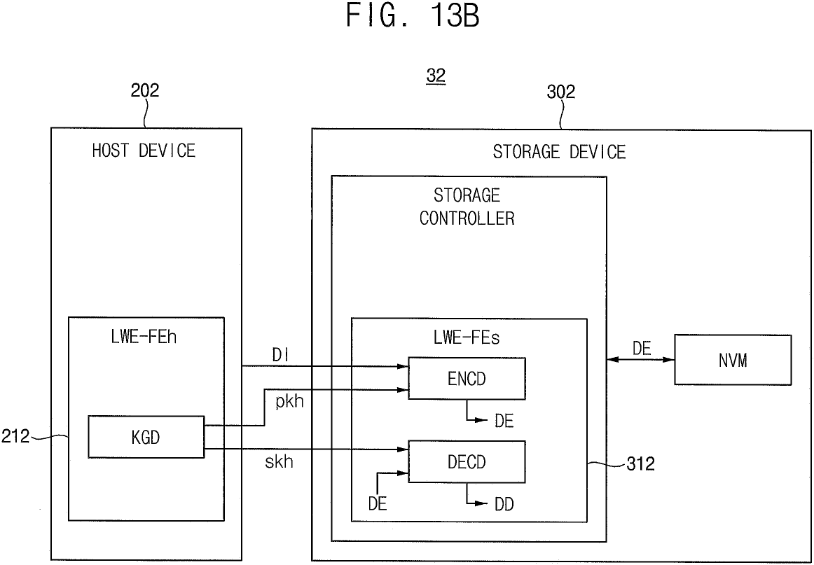

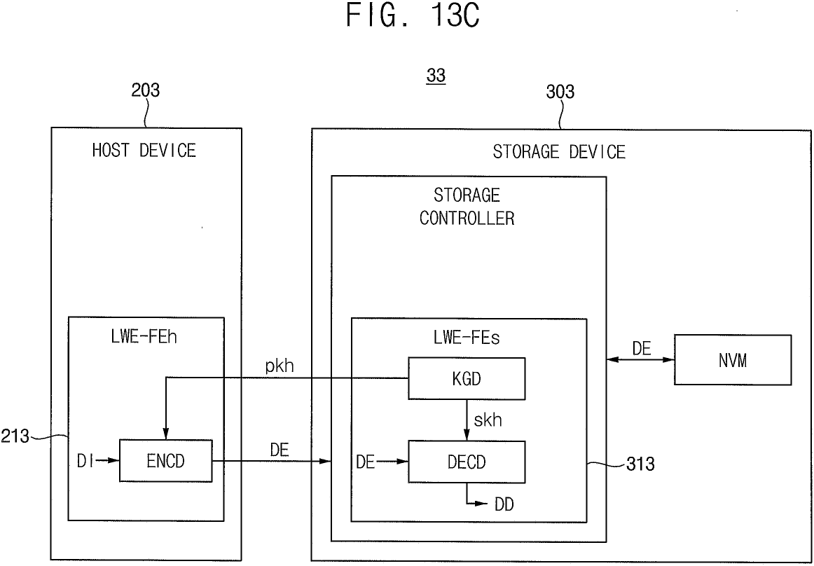

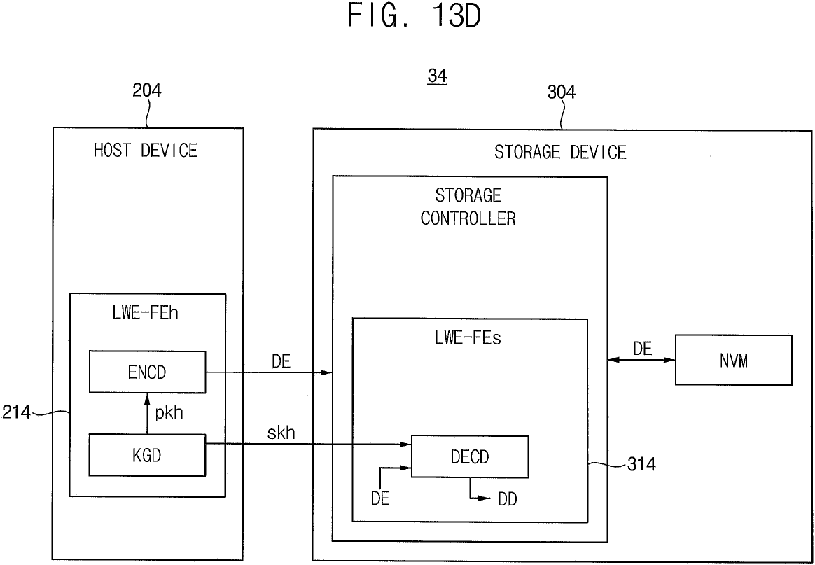

Hereinafter, example embodiments of distributing functions for performing the functional encryption to the host device and the storage device with reference to FIGS. 13A through 13D.

FIGS. 13A, 13B, 13C and 13D are block diagrams illustrating a storage system according to example embodiments. FIGS. 13A through 13D illustrate only components for describing example embodiments and descriptions repeated with FIGS. 1 through 12 may be omitted.

Referring to FIGS. 13A, 13B, 13C and 13D, storage systems 31, 32, 33 and 34 may include host devices 201, 202, 203 and 204 and storage devices 301, 302, 303 and 304, respectively. Each of the storage devices 301, 302, 303 and 304 may include a nonvolatile memory device NVM.

Referring to FIG. 13A, the storage functional encryption device LWE-FEs included in the storage controller may include a key generator KGD, an encryptor ENCD and a decryptor DECD. The key generator KGD may generate the public key pkh and the secret key skh. The encpytor ENCD may receive the input data DI of the machine learning model from the host device 201, receive the public key pkh from the key generator KGD, and generate the encrypted data DE by encrypting the input data DI. The decryptor DECD may receive the secret key skh from the key generator KGD, and generate the decrypted data DD by decrypting the encrypted data DE.

In some example embodiments, the storage controller may store the encrypted data DE in the nonvolatile memory device NVM. When the machine learning engine performs training or inference of the machine learning model, the storage controller may generate the decrypted data DD by reading the encrypted data DE from the nonvolatile memory device NVM and decrypting the encrypted data DE.

Referring to FIG. 13B, the host device 202 may include the host functional encryption device LWE-FEh 212 and the storage controller of the storage device 302 may include the storage functional encryption device LWE-FEs.

The host functional encryption device LWE-FEh may include a key generator KGD configured to generate the public key pkh and the secret key skh. The storage functional encryption device LWE-FEs may include an encpytor ENCD configured to receive the public key pkh and the input data DI from the host device 202, and generate the encrypted data DE by encrypting the input data DI, and a decryptor DECD configured to receive the secret key skh from the host device 202, and generate the decrypted data DD by decrypting the encrypted data DE.

Referring to FIG. 13C, the host device 203 may include the host functional encryption device LWE-FEh 213 and the storage controller of the storage device 303 may include the storage functional encryption device LWE-FEs.

The host functional encryption device LWE-FEh may include an encpytor ENCD configured to receive the public key pkh from the storage device 303, and generate the encrypted data DE by encrypting the input data DI. The storage functional encryption device LWE-FEs may include a key generator KGD configured to generate the public key pkh and the secret key skh, and a decryptor DECD configured to receive the encrypted data DE from the host device 203, and generate the decrypted data DD by decrypting the encrypted data DE.

Referring to FIG. 13D, the host device 204 may include the host functional encryption device LWE-FEh 214 and the storage controller of the storage device 304 may include the storage functional encryption device LWE-FEs.

The host functional encryption device LWE-FEh may include a key generator KGD configured to generate the public key pkh and the secret key skh, and an encpytor ENCD configured to receive the public key pkh from the key generator KGD, and generate the encrypted data DE by encrypting the input data DI. The storage functional encryption device LWE-FEs may include a decryptor DECD configured to receive the secret key skh and the encrypted data DE from the host device 204, and generate the decrypted data DD by decrypting the encrypted data DE.

FIG. 14 is a flowchart illustrating a method of controlling a machine learning model according to example embodiments, and FIG. 15 is a diagram illustrating a configuration corresponding to the method of FIG. 14.

Referring to FIGS. 14 and 15, training of the machine learning model may be performed based on the input data corresponding to training data (S500), and inference of the machine learning model may be performed based on the decrypted data corresponding to inference data (S600).

During the training operation, the input vector x indicating the input data may be applied to the input layer IL, and the first hidden layer HL1 may perform the node operations based on the input vector x and output the m node output values y11~ylm corresponding to the m hidden nodes in the first hidden layer HL1.

During the inference operation, the decryptor DECD may replace the input layer IL and the first hidden layer HL1. The decryptor DECD may receive the m node encrypted data c1~cm and the m secret key vectors skh1-skhm respectively corresponding to the m hidden nodes in the first hidden layer HL1, and output the m node output values y11′-y1m′ respectively corresponding to the m hidden nodes. The m node output values y11′~y1m′ may correspond to the decrypted data DD indicating the approximation value of the parameter vector and the input vector as described above.

The machine learning engine may include a selector MUX, The selector MUX may select the m node output values y11~y1m during the training operation and the m node output values y11′~yl′ during the inference operation to provide the selected data to the second hidden layer HL2.

As shown in FIGS. 14 and 15, the weight values and the bias values of the first hidden layer HL1 may be updated in example embodiments. In this regard, the parameter vector used in the inference of the machine learning model may include optimized weight values and optimized bias values of the first hidden layer HL1 that are determined depending on results of the training of the machine learning model after the training of the machine learning model is completed.

FIG. 16 is a flowchart illustrating a method of controlling a machine learning model according to example embodiments, and FIG. 17 is a diagram illustrating a configuration corresponding to the method of FIG. 16.

Referring to FIGS. 16 and 17, training of the machine learning model may be performed based on first decrypted data corresponding to training data (S501), and inference of the machine learning model may be performed based on second decrypted data corresponding to inference data (S601).

Regardless of training and inference operations, the decryptor DECD may replace the input layer IL and the first hidden layer HL1. The decryptor DECD may receive the m node encrypted data c1~cm and the m secret key vectors skh1~skhm respectively corresponding to the m hidden nodes in the first hidden layer HL1, and output the m node output values y11′~ylm’ respectively corresponding to the m hidden nodes. The m node output values y11′~y1m′ may correspond to the decrypted data DD indicating the approximation value of the parameter vector and the input vector as described above.

The parameter vector used in the training of the machine learning model may include initial weight values and initial bias values of the first hidden layer. The initial weight values and the initial bias values may be determined when the machine learning model is designed.

In some example embodiments, weight values and bias values of the first hidden layer HL1 may not be updated, and may be fixed to the initial weight values and the initial bias values during the training of the machine learning model. As a result, the parameter vector used in the inference of the machine learning model may be equal to the parameter vector used in the training of the machine learning model. In this case, the first hidden layer HL1 may be a kind of dummy layer for implementing security.

In some example embodiments, weight values and bias values of the first hidden layer may be updated during the training of the machine learning model. In this case, the parameter vector used in the inference of the machine learning model may include optimized weight values and optimized bias values of the first hidden layer HL1 that are determined depending on results of the training of the machine learning model after the training of the machine learning model is completed.

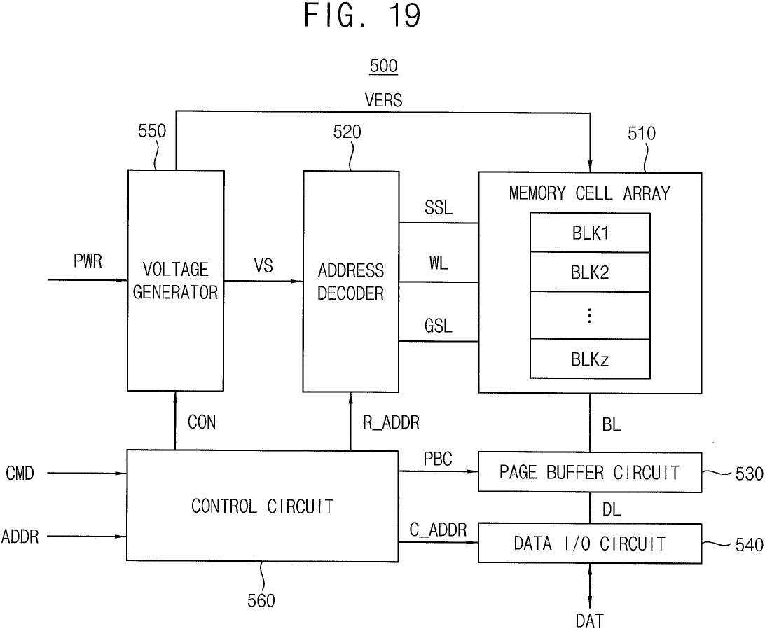

FIG. 18 is a block diagram illustrating a storage controller included in a storage device according to example embodiments.

Referring to FIG. 18, a storage controller 400 may include a processor 410, a memory 420, a machine learning engine MLE 431, a functional encryption device LWE-FE 432, a host interface 440, an error correction code (ECC) engine 450, a memory interface 460 and an advanced encryption standard (AES) engine 470. For example, the storage controller 400 may correspond to the storage controller 310 in FIG. 2.

The processor 410 may control an operation of the storage controller 400 according to a command received via the host interface 440 from a host device (e.g., the host device 200 in FIG. 12). For example, the processor 410 may control an operation of a storage device (e.g., the storage device 300 of FIG. 12), and may control respective components by employing firmware for operating the storage device.

The memory 420 may store instructions and data executed and processed by the processor 410. For example, the memory 420 may be implemented with a volatile memory, such as a DRAM, a SRAM, a cache memory, or the like.

The functional encryption device 432 may include at least one of the key generator, the encryptor and the decryptor as described above. The functional encryption device 432 may generate the decrypted data replacing the input data of the machine learning model MLM by applying the functional encryption using the LWE problem and the lattice problem according to example embodiments. The machine learning engine 431 may control the machine learning model MLM based on the decrypted data.

The ECC engine 450 for error correction may perform coded modulation using a Bose-Chaudhuri-Hocquenghem (BCH) code, a low density parity check (LDPC) code, a turbo code, a Reed-Solomon code, a convolution code, a recursive systematic code (RSC), a trellis-coded modulation (TCM), a block coded modulation (BCM), etc., or may perform ECC encoding and ECC decoding using above-described codes or other error correction codes.

The host interface 440 may provide physical connections between the host device and the storage device. The host interface 440 may provide an interface corresponding to a bus format of the host device for communication between the host device and the storage device. In some example embodiments, the bus format of the host device may be a small computer system interface (SCSI) or a serial attached SCSI (SAS) interface. In other example embodiments, the bus format of the host device may be a USB, a peripheral component interconnect (PCI) express (PCIe), an advanced technology attachment (ATA), a parallel ATA (PATA), an SATA, a nonvolatile memory (NVM) express (NVMe), etc., format.

The memory interface 460 may exchange data with a nonvolatile memory (e.g., the nonvolatile memories 320a, 320b and 320c in FIG. 2). The memory interface 460 may transfer data to the nonvolatile memory, or may receive data read from the nonvolatile memory. In some example embodiments, the memory interface 460 may be connected to the nonvolatile memory via one channel. In other example embodiments, the memory interface 460 may be connected to the nonvolatile memory via two or more channels. For example, the memory interface 460 may be configured to comply with a standard protocol, such as Toggle or open NAND flash interface (ONFI).

The AES engine 470 may perform at least one of an encryption operation and a decryption operation on user data input to the storage controller 400 using a symmetric-key algorithm. The AES engine 470 may include an encryption module and a decryption module. For example, the encryption module and the decryption module may be implemented as separate modules. For another example, one module capable of performing both encryption and decryption operations may be implemented in the AES engine 470.

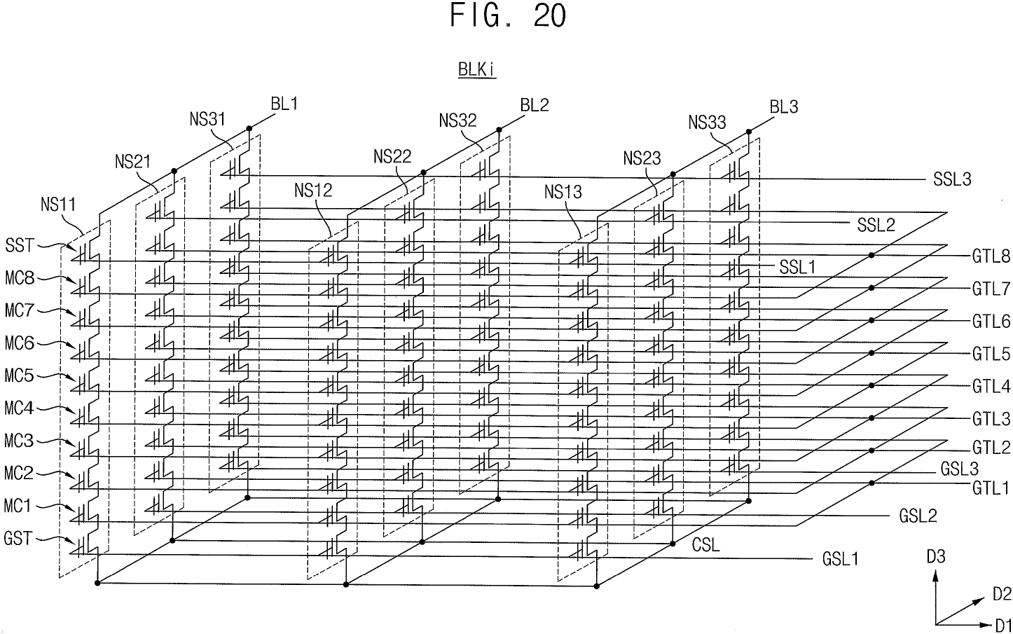

FIG. 19 is a block diagram illustrating a nonvolatile memory device included in a storage device according to example embodiments.

Referring to FIG. 19, a nonvolatile memory 500 includes a memory cell array 510, an address decoder 520, a page buffer circuit 530, a data I/O circuit 540, a voltage generator 550 and a control circuit 560.

The memory cell array 510 is connected to the address decoder 520 via a plurality of string selection lines SSL, a plurality of wordlines WL and a plurality of ground selection lines GSL. The memory cell array 510 is further connected to the page buffer circuit 530 via a plurality of bitlines BL. The memory cell array 510 may include a plurality of memory cells (e.g., a plurality of nonvolatile memory cells) that are connected to the plurality of wordlines WL and the plurality of bitlines BL. The memory cell array 510 may include a plurality of memory blocks BLK1, BLK2, ..., BLKz, each of which includes memory cells. In addition, each of the plurality of memory blocks BLK1, BLK2, ..., BLKz may include a plurality of pages.

In some example embodiments, the plurality of memory cells included in the memory cell array 510 may be arranged in a two-dimensional (2D) array structure or a three-dimensional (3D) vertical array structure. The memory cell array of the 3D vertical array structure will be described below with reference to FIG. 24.

The control circuit 560 receives a command CMD and an address ADDR from an external device (e.g., from the storage controller 310 in FIG. 2), and controls erasure, programming and read operations of the nonvolatile memory 500 based on the command CMD and the address ADDR. An erasure operation may include performing a sequence of erase loops, and a program operation may include performing a sequence of program loops. Each program loop may include a program operation and a program verification operation. Each erase loop may include an erase operation and an erase verification operation. The read operation may include a normal read operation and data recover read operation.

For example, the control circuit 560 may generate control signals CON, which are used for controlling the voltage generator 550, and may generate control signal PBC for controlling the page buffer circuit 530, based on the command CMD, and may generate a row address R_ADDR and a column address C_ADDR based on the address ADDR. The control circuit 560 may provide the row address R_ADDR to the address decoder 520 and may provide the column address C_ADDR to the data I/O circuit 540.

The address decoder 520 may be connected to the memory cell array 510 via the plurality of string selection lines SSL, the plurality of wordlines WL and the plurality of ground selection lines GSL.

For example, in the data erase/write/read operations, the address decoder 520 may determine at least one of the plurality of wordlines WL as a selected wordline, and may determine the remaining wordlines, other than the selected wordline, as unselected wordlines, based on the row address R_ADDR.

In addition, in the data erase/write/read operations, the address decoder 520 may determine at least one of the plurality of string selection lines SSL as a selected string selection line, and may determine the remaining string selection lines, other than the selected string selection line, as unselected string selection lines, based on the row address R_ADDR.

Further, in the data erase/write/read operations, the address decoder 520 may determine at least one of the plurality of ground selection lines GSL as a selected ground selection line, and may determine the remaining ground selection lines, other than the selected ground selection line, as unselected ground selection lines, based on the row address R_ADDR.

The voltage generator 550 may generate voltages VS that are required for an operation of the nonvolatile memory 500 based on a power PWR and the control signals CON. The voltages VS may be applied to the plurality of string selection lines SSL, the plurality of wordlines WL and the plurality of ground selection lines GSL via the address decoder 520. In addition, the voltage generator 550 may generate an erase voltage that is required for the data erase operation based on the power PWR and the control signals CON. The erase voltage may be applied to the memory cell array 510 directly or via the bitline BL.

For example, during the erase operation, the voltage generator 550 may apply the erase voltage to a common source line and/or the bitline BL of a memory block (e.g., a selected memory block) and may apply an erase permission voltage (e.g., a ground voltage) to all wordlines of the memory block or a portion of the wordlines via the address decoder 520. In addition, during the erase verification operation, the voltage generator 550 may apply an erase verification voltage simultaneously to all wordlines of the memory block or sequentially to the wordlines one by one.

For example, during the program operation, the voltage generator 550 may apply a program voltage to the selected wordline and may apply a program pass voltage to the unselected wordlines via the address decoder 520. In addition, during the program verification operation, the voltage generator 550 may apply a program verification voltage to the selected wordline and may apply a verification pass voltage to the unselected wordlines via the address decoder 520.

In addition, during the normal read operation, the voltage generator 550 may apply a read voltage to the selected wordline and may apply a read pass voltage to the unselected wordlines via the address decoder 520. During the data recover read operation, the voltage generator 550 may apply the read voltage to a wordline adjacent to the selected wordline and may apply a recover read voltage to the selected wordline via the address decoder 520.

The page buffer circuit 530 may be connected to the memory cell array 510 via the plurality of bitlines BL. The page buffer circuit 530 may include a plurality of page buffers. In some example embodiments, each page buffer may be connected to one bitline. In other example embodiments, each page buffer may be connected to two or more bitlines.

The page buffer circuit 530 may store data DAT to be programmed into the memory cell array 510 or may read data DAT sensed (i.e., read) from the memory cell array 510. In this regard, the page buffer circuit 530 may operate as a write driver or a sensing amplifier according to an operation mode of the nonvolatile memory 500.

The data I/O circuit 540 may be connected to the page buffer circuit 530 via data lines DL. The data I/O circuit 540 may provide the data DAT from the outside of the nonvolatile memory 500 to the memory cell array 510 via the page buffer circuit 530 or may provide the data DAT from the memory cell array 510 to the outside of the nonvolatile memory 500, based on the column address C_ADDR.

Although the nonvolatile memory is described as a NAND flash memory, example embodiments are not limited thereto, and the nonvolatile memory may be any nonvolatile memory, e.g., a phase random access memory (PRAM), a resistive random access memory (RRAM), a nano floating gate memory (NFGM), a polymer random access memory (PoRAM), a magnetic random access memory (MRAM), a ferroelectric random access memory (FRAM), a thyristor random access memory (TRAM), or the like.

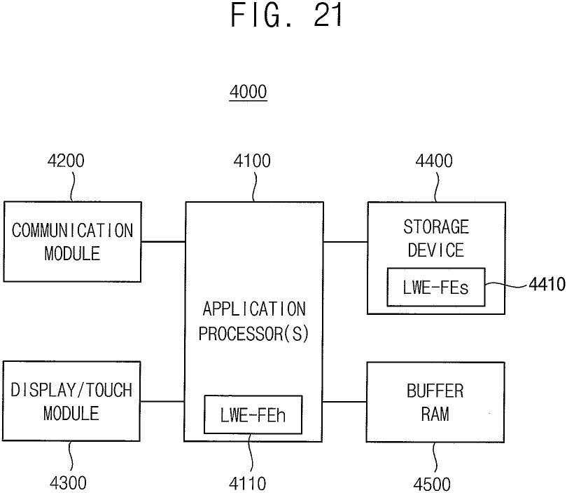

FIG. 20 is a circuit diagram illustrating an equivalent circuit of a memory block included in a nonvolatile memory device.

Referring to FIG. 20, each memory block BLKi included in the memory cell arra y 510 in FIG. 5 may be formed on a substrate in a three-dimensional structure (or a vertical structure). For example, NAND strings or cell strings included in the memory block BLKi may be formed in a vertical direction D3 perpendicular to an upper surface of a substrate. A first direction D1 and a second direction D2 are parallel to the upper surface of the substrate.

The memory block BLKi may include NAND strings NS11 to NS33 coupled between bitlines BL1, BL2, and BL3 and a common source line CSL. Each of the NAND strings NS11 to NS33 may include a string selection transistor SST, a memory cells MC1 to MC8, and a ground selection transistor GST. In FIG. 20, each of the NAND strings NS11 to NS33 is illustrated to include eight memory cells MC1 to MC8. However, example embodiments are not limited thereto, and each of the NAND strings NS11 to NS33 may include various numbers of memory cells.

Each string selection transistor SST may be connected to a corresponding string selection line (one of SSL1 to SSL3). The memory cells MC1 to MC8 may be connected to corresponding gate lines GTL1 to GTL8, respectively. The gate lines GTL1 to GTL8 may be wordlines, and some of the gate lines GTL1 to GTL8 may be dummy wordlines. Each ground selection transistor GST may be connected to a corresponding ground selection line (one of GSL1 to GSL3). Each string selection transistor SST may be connected to a corresponding bitline (e.g., one of BL1, BL2, and BL3), and each ground selection transistor GST may be connected to the common source line CSL.

Wordlines (e.g., WL1) having the same height may be commonly connected, and the ground selection lines GSL1 to GSL3 and the string selection lines SSL1 to SSL3 may be separated. In FIG. 20, the memory block BLKi is illustrated as being coupled to eight gate lines GTL1 to GTL8 and three bitlines BL1 to BL3. However, example embodiments are not limited thereto, and each memory block in the memory cell array 510 may be coupled to various numbers of wordlines and various numbers of bitlines.

FIG. 21 is a block diagram illustrating an electronic device according to example embodiments.

Referring to FIG. 21, an electronic device 4000 may include an application processor 4100, a communication module 4200 (e.g., a communicator), a display/touch module 4300 (e.g., a touch panel), a storage device 4400, and a buffer RAM 4500. The application processor 4100 may control operations of the electronic device 4000. The communication module 4200 may be implemented to perform wireless or wired communications with an external device. The display/touch module 4300 may be implemented to display data processed by the application processor 4100 or to receive data through a touch panel.

The storage device 4400 may be implemented to store user data. The storage device 4400 may be a solid state drive (SSD), an embedded multimedia card (eMMC), a universal flash storage (UFS), etc.

The buffer RAM 4500 may temporarily store data used for processing operations of the electronic device 4000. For example, the buffer RAM may be a dynamic random access memory (DRAM) such as a double data rate (DDR), synchronous DRAM (SDRAM), a graphics DDR (GDDR) DRAM, a Rambus DRAM (RDRAM), etc.

According to example embodiments, the application processor 4100 may include a host functional encryption device LWE-FEh 4110, and the storage device 4400 may include a storage functional encryption device LWE-FEs. As described with reference to FIGS. 13A through 13D, the functions of the functional encryption using the LWE problem and the lattice problem may be distributed in the host functional encryption device 4110 and the storage functional encryption device 4410.

As described above, the method of controlling a machine learning model and the system according to example embodiments may reinforce security of data used in machine learning and block attacks using quantum computers by incurring random noise in the encrypted data based on the functional encryption using the LWE problem and the lattice problem.

Example embodiments may be applied to various electronic devices and systems that include a storage device. For example, example embodiments may be applied to systems such as a memory card, a solid state drive (SSD), an embedded multimedia card (eMMC), a universal flash storage (UFS), a mobile phone, a smart phone, a personal digital assistant (PDA), a portable multimedia player (PMP), a digital camera, a camcorder, a personal computer (PC), a server computer, a workstation, a laptop computer, a digital TV, a set-top box, a portable game console, a navigation system, a wearable device, an internet of things (IoT) device, an internet of everything (IoE) device, an e-book, a virtual reality (VR) device, an augmented reality (AR) device, a server system, an automotive driving system, etc.

At least one of the components, elements, modules or units represented by a block as illustrated in FIGS. 1, 3, 10-12, 13A, 13B, 13C, 13D, 15, 17-19 and 21, may be embodied as various numbers of hardware, software and/or firmware structures that execute respective functions described above, according to example embodiments. For example, at least one of these components, elements, modules or units may include various hardware components including circuitry using use a direct circuit structure, such as a memory, a processor, a logic circuit, a look-up table, etc., that may execute the respective functions through controls of one or more microprocessors or other control apparatuses. Also, at least one of these components, elements, modules or units may include a module, a program, or a part of code, which contains one or more executable instructions for performing specified logic functions, and executed by one or more microprocessors or other control apparatuses. Also, at least one of these components, elements, modules or units may further include or may be implemented by a processor such as a central processing unit (CPU) that performs the respective functions, a microprocessor, or the like. Functional aspects of example embodiments may be implemented in algorithms that execute on one or more processors. Furthermore, the components, elements, modules or units represented by a block or processing steps may employ any number of related art techniques for electronics configuration, signal processing and/or control, data processing and the like.

While aspects of example embodiments have been particularly shown and described, it will be understood that various changes in form and details may be made therein without departing from the spirit and scope of the following claims.

What is claimed is:

1. A method comprising:
generating a public key and a secret key, based on a master key and a parameter vector indicating parameters of a first layer of a machine learning model;
generating encrypted data by encrypting, based on the public key, an input vector indicating input data of the machine learning model;
generating decrypted data corresponding to an approximation value of an inner product of the parameter vector and the input vector by decrypting the encrypted data based on the secret key; and
controlling the machine learning model based on the decrypted data to obtain an output value.

2. The method of claim 1, further comprising applying the decrypted data as input to a second layer of the machine learning model.

3. The method of claim 1, wherein the parameter vector comprises a plurality of node parameter vectors respectively corresponding to a plurality of nodes in the first layer,
wherein the secret key comprises a plurality of secret key vectors respectively corresponding to the plurality of nodes in the first layer,
wherein the public key comprises a plurality of public key vectors respectively corresponding to the plurality of nodes in the first layer,
wherein the encrypted data comprise a plurality of node encrypted data respectively corresponding to the plurality of nodes in the first layer, and
wherein the decrypted data comprise a plurality of node output values respectively corresponding to the plurality of nodes in the first layer.

4. The method of claim 3, wherein the input vector and the plurality of node parameter vectors are generated according to following expressions:
$$\text{x=} \left(1 , \text{x1, x2,} ⋯ \text{, xn}\right) , \text{and}$$
$$\text{hj=} \left(\text{bj, w1j, w2j,} ⋯ \text{, wnj}\right) \text{, and}$$
wherein x indicates the input vector, x1 through xn indicate input values of the input vector, hj indicates a node parameter vector corresponding to a j-th node in the first layer, bj indicates a bias value corresponding to the j-th node, and wlj through wnj indicate weight values corresponding to the j-th node.

5. The method of claim 1, further comprising:
training the machine learning model based on the input data corresponding to training data; and
performing inference of the machine learning model based on the decrypted data corresponding to inference data.

6. The method of claim 5, wherein the parameter vector used in the inference of the machine learning model comprises optimized weight values and optimized bias values of the first layer that are determined based on results of the training after the training is completed.

7. The method of claim 1, further comprising:
training the machine learning model based on first decrypted data corresponding to training data; and
performing inference of the machine learning model based on second decrypted data corresponding to inference data.

8. The method of claim 7, wherein the parameter vector used in the training comprises initial weight values and initial bias values of the first layer.

9. The method of claim 8, wherein weight values and bias values of the first layer are fixed to the initial weight values and the initial bias values during the training.

10. The method of claim 9, wherein the parameter vector used in the inference of the machine learning model corresponds to the parameter vector used in the training.

11. The method of claim 8, wherein weight values and bias values of the first layer are updated during the training.

12. The method of claim 11, wherein the parameter vector used in the inference of the machine learning model comprises optimized weight values and optimized bias values of the first layer that are determined based on results of the training after the training is completed.

13. The method of claim 1, further comprising generating the public key, the secret key, the encrypted data and the decrypted data based on functional encryption using a learning with error (LWE) problem and a lattice problem.

14. A system comprising;
a storage device comprising a storage controller and a nonvolatile memory device, the storage controller comprising a processor configured to control a machine learning model; and
a host device configured to control the storage device,
wherein the system is configured to:
generate a public key and a secret key, based on a master key and a parameter vector indicating parameters of a first layer of the machine learning model;
generate encrypted data by encrypting, based on the public key, an input vector indicating input data of the machine learning model;
generate decrypted data corresponding to an approximation value of an inner product of the parameter vector and the input vector by decrypting the encrypted data based on the secret key; and
control the machine learning model based on the decrypted data to obtain an output value.

15. The system of claim 14, wherein the processor is further configured to control:
a key generator to generate the public key and the secret key;
an encpytor to receive the input data from the host device, receive the public key from the key generator, and generate the encrypted data by encrypting the input data; and
a decryptor to receive the secret key from the key generator, and generate the decrypted data by decrypting the encrypted data.

16. The system of claim 14, wherein the host device comprises a host processor configured to control a key generator to generate the public key and the secret key, and
wherein the processor of the storage controller is further configured to control:
an encpytor to receive the public key and the input data from the host device, and generate the encrypted data by encrypting the input data; and
a decryptor to receive the secret key from the host device, and generate the decrypted data by decrypting the encrypted data.

17. The system of claim 14, wherein the host device comprises a host processor configured to control an encpytor to receive the public key from the storage device, and generate the encrypted data by encrypting the input data, and
wherein the processor of the storage controller is further configured to control:
a key generator to generate the public key and the secret key; and
a decryptor to receive the encrypted data from the host device, and generate the decrypted data by decrypting the encrypted data.

18. The system of claim 14, wherein the host device comprises a host processor configured to control:
a key generator to generate the public key and the secret key; and
an encpytor to receive the public key from the key generator, and generate the encrypted data by encrypting the input data, and
wherein the processor of the storage controller is further configured to control a decryptor to receive the secret key and the encrypted data from the host device, and generate the decrypted data by decrypting the encrypted data.

19. The system of claim 14, wherein the storage controller is configured to store the encrypted data in the nonvolatile memory device, and generate the decrypted data by reading the encrypted data from the nonvolatile memory device and decrypting the encrypted data.

20. A system comprising:
one or more memories; and
one or more processors configured to control:
a key generation device to generate a public key and a secret key, based on a master key and a parameter vector indicating parameters of a first layer of a machine learning model;
an encryption device to generate encrypted data by encrypting, based on the public key, an input vector indicating input data of the machine learning model;
a decryption device to generate decrypted data corresponding to an approximation value of an inner product of the parameter vector and the input vector by decrypting the encrypted data based on the secret key; and
a machine learning engine to receive the decrypted data from the decryption device and control the machine learning model based on the decrypted data to obtain an output value.
